(19) United States
(12) Patent Application Publication
(10) Pub. No.: US 2010/0277895 A1
(43) Pub. Date: Nov. 4, 2010

(54) SOLAR-CHARGED WARNING DEVICE

(75) Inventor: Mei-Feng HUANG, Tanzih Township (TW)

Correspondence Address: Ching-Ling Huang, 5597 NW 127th Ter, Portland, OR, 97229, US

(73) Assignees: Mei-Feng HUANG, Tanzih Township (TW); TRANS-CHIEF CO., LTD, Changhua City (TW); INTELLIGENCE HEALTH TECHNOLOGY CO., LTD, Taichung City (TW)

(21) Appl. No.: 12/434,687

(22) Filed: May 4, 2009

(51) Int. Cl. F21V 21/084; F21L 4/00; H01M 10/46

(52) U.S. Cl. 362/105; 362/183; 320/101

(57) ABSTRACT

The present invention discloses a solar-charged warning device, mounted on a helmet, including at least one light-emitting element, a solar photovoltaic panel, a voltage amplifier circuit, a sensor circuit, a charge/discharge circuit, and a secondary battery. The solar photovoltaic panel mounted on the helmet is used to absorb the solar energy and transform thereof into the electricity, and then the electricity is inputted into the sensor circuit, the charge/discharge circuit and the secondary battery, for storing the electricity in the secondary battery. When there needs the electricity, it can be discharged by the charge/discharge circuit and then amplified by the voltage amplifier circuit to reach the required voltage, so as to drive the light-emitting element to shine. When there exists the light source, the secondary battery will be charged. When in the dark, the electricity stored in the secondary battery will be discharged to drive the light-emitting element to shine.

### FIELD OF THE INVENTION

The present invention is related to a warning device, and more particularly to a warning device for a helmet of a rider.

### BACKGROUND OF THE INVENTION

Please refer to FIG. 1. For riders, the helmet 1 is widely used since it can reduce the damage as the traffic accidence occurs. Conventionally, for enhancing the visibility of the helmet 1 at night, a reflector 2 is mounted thereon, so that the reflection light from the reflector 2 can recognize the position of the helmet 1. However, since the reflector only radiates light without the light source, it is difficult to recognize the helmet 1 in the dark.

Further, please refer to FIG. 2, in which for increasing the warning effect, a warning device 3 is mounted on the helmet 1. The warning device 3 includes two batteries 4 and at least one light source 5, wherein the light source 5 is powered by the two batteries 4, so that even in the dark, the warning effect still can be maintained. In addition, a switch 6 is also provided to power on or off the warning device 3. However, since the electricity provided by the batteries 4 is easily exhausted by the light source 5 in a short period of time, the user has to replace the batteries 4 very often, so that as the batteries are not replaced in time, the warning device might not function properly. Besides, for providing sufficient output voltage, the batteries 4 have to connect in series, so that the occupied space and the location of the batteries are both limited. Plus, the extra batteries increase the total weight of the helmet 1.

### SUMMARY OF THE INVENTION

Therefore, the object of the present invention is to provide a warning device which is automatically charged by the solar energy so as to eliminate the inconvenience of battery replacement.

Another object of the present invention is to provide a warning device with voltage amplifier circuit, so that the power unit of the warning device can be configured to have a smaller voltage potential, thereby the occupied volume thereof can be reduced.

The present invention is related to a solar-charged warning device, mounted on a helmet, including a solar photovoltaic panel, a charge/discharge circuit, a secondary battery, a voltage amplifier circuit, and at least one light-emitting element. The solar photovoltaic panel is mounted on the outer surface of the helmet for absorbing the solar energy and transforming thereof into electricity. The charge/discharge circuit is electrically connected to the solar photovoltaic panel via a first electrical conduction wire. The secondary battery is electrically connected to the charge/discharge circuit via a second electrical conduction wire for receiving and storing the electricity produced from the solar photovoltaic panel, and provided to the secondary battery by the charge/discharge circuit. The voltage amplifier circuit is electrically connected to the charge/discharge circuit for amplifying the voltage of the power form the secondary battery. The light-emitting element is mounted on the outer surface of the helmet and electrically connected to the voltage amplifier circuit via a third electrical conduction wire, so that the amplified voltage from the voltage amplifier circuit can drive the light-emitting element to shine.

Accordingly, the present invention utilizes the solar photovoltaic panel to absorb the solar energy and transform thereof into the electricity, which is then used to charge the secondary battery, so that as the light source is absent, the secondary battery can be discharged to drive the light-emitting element to shine. Therefore, even the helmet is used in a dark environment, the light-emitting element also can shine to provide the warning effect and secure the user's safety.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a schematic view showing a conventional warning device for a helmet;

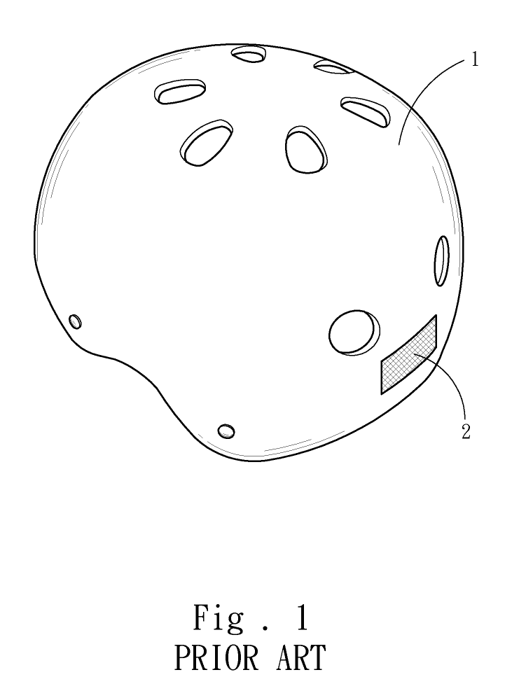

FIG. 2 is a schematic view showing another conventional warning device for a helmet;

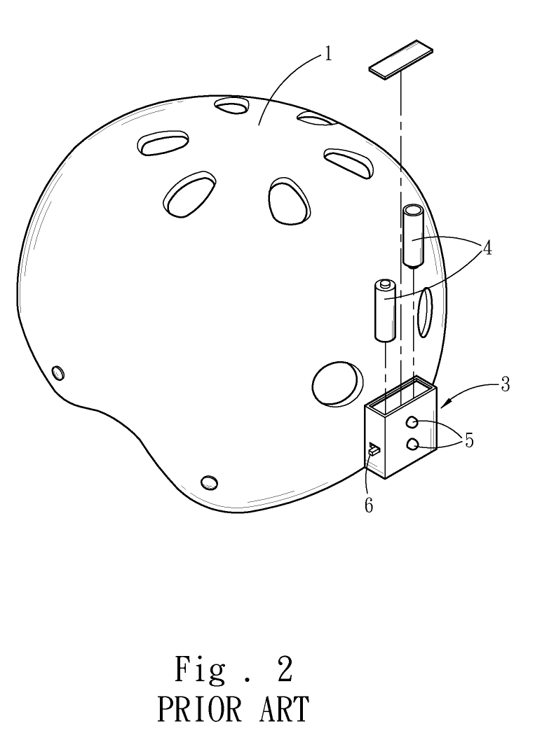

FIG. 3 is a schematic view showing a warning device for a helmet according to the present invention;

FIG. 4 is a decomposition drawing showing the warning device according to the present invention; and

FIG. 5 is a circuit block diagram of the present invention.

### DESCRIPTION OF THE PREFERRED EMBODIMENT

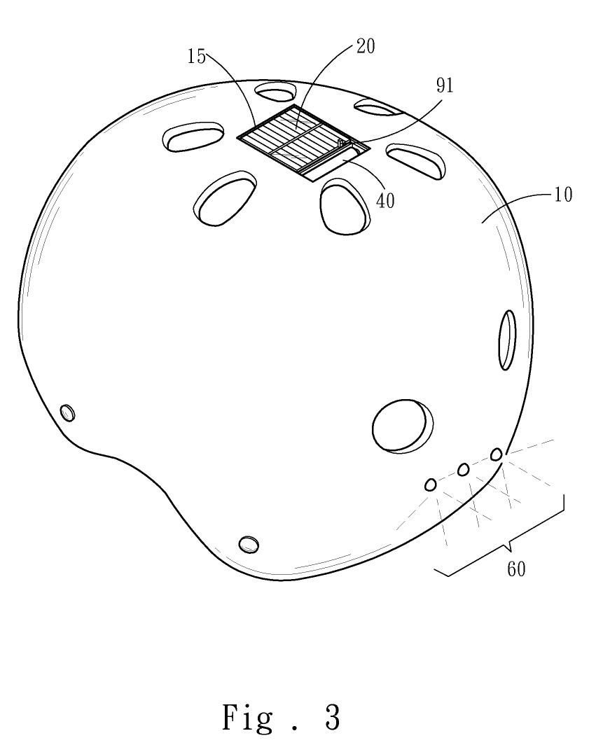

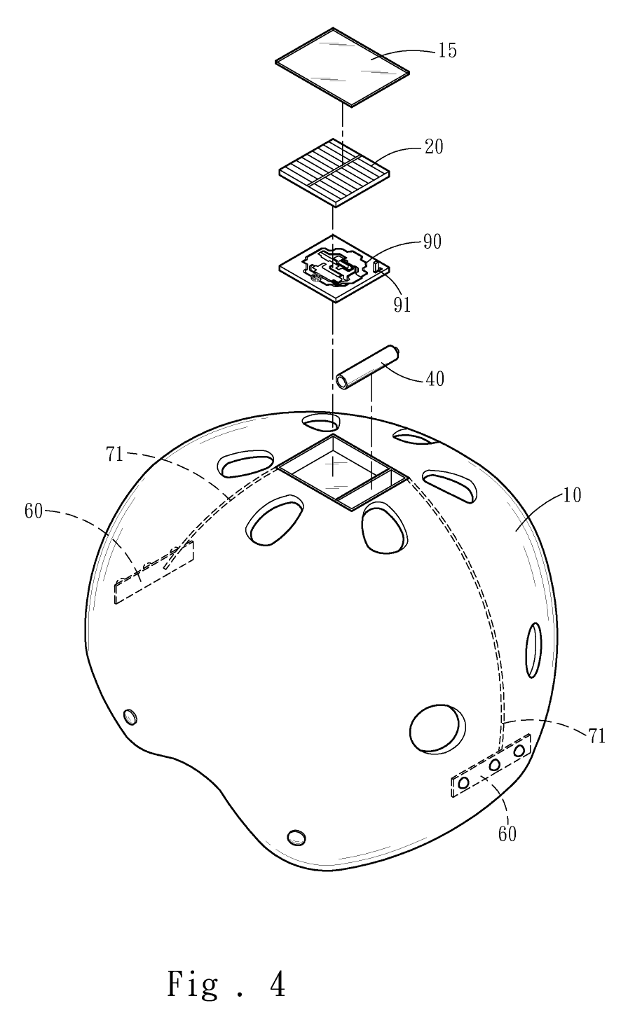

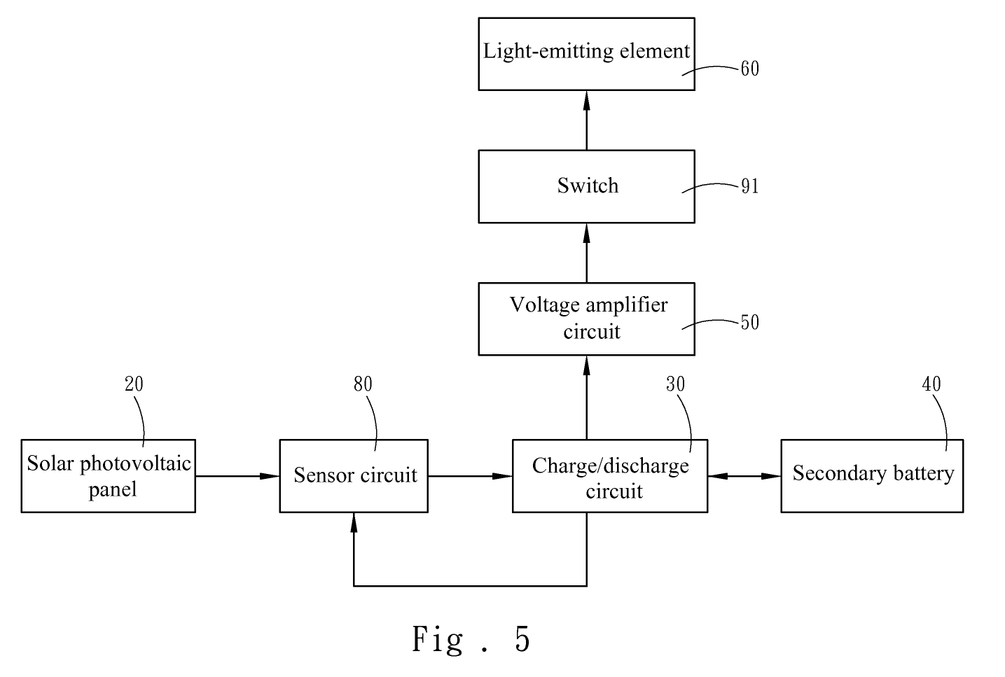

Please refer to FIG. 3, FIG. 4 and FIG. 5. The present invention is related to a solar-charged warning device which is mounted on a helmet 10. The solar-charged warning device includes a solar photovoltaic panel 20, a charge/discharge circuit 30, a secondary battery 40, a voltage amplifier circuit 50 and at least one light-emitting element 60, wherein the solar photovoltaic panel 20 is mounted on the outer surface of the helmet 10 to absorb the light and transform thereof into electricity. Here, a transparent sheet 15 also can be provided on the solar photovoltaic panel 20 to protect the solar photovoltaic panel 20.

The solar photovoltaic panel 20 is electrically connected to the charge/discharge circuit 30, and the secondary battery 40 is electrically connected to the charge/discharge circuit 30 for receiving and storing the electricity produced from the solar photovoltaic panel 20. Here, the secondary battery 40 can be selected from a Li battery, a Ni—H battery or a storage battery, and the secondary battery 40 is powered by the charge/discharge circuit 30. The voltage amplifier circuit 50 is electrically connected to the charge/discharge circuit 30 for amplifying the voltage of the power provided by the secondary battery 40. Besides, the helmet 10 also includes a circuit board 90 therein for mounting the charge/discharge circuit 30 and the voltage amplifier circuit 50.

Further, a sensor circuit 80 is located between the solar photovoltaic panel 20 and the charge/discharge circuit 30, and the charge/discharge circuit 30 is feedback to the sensor circuit 80. When there detects the electricity produced from the solar photovoltaic panel 20, the sensor circuit 80 controls the charge/discharge circuit 30 to charge the secondary battery 40, and when there detects no electricity produced from the solar photovoltaic panel 20, the sensor circuit 80 controls the charge/discharge circuit 30 to discharge the secondary battery 40. Moreover, the circuit board 90 also can include a switch 91, by changing the conduction condition thereof, deciding if the secondary battery 40 is discharged or not, so as to reduce the power consumption of the secondary battery 40.

The light-emitting element 60 is mounted on the outer surface of the helmet 10, for example, the light-emitting element 60 can be mounted at the front and the rear ends of the helmet 10, respectively. Here, the light-emitting element 60 can be an LED (Light-Emitting Diode). Moreover, the light-emitting element 60 is electrically connected to the voltage amplifier circuit 50 via an electrical conduction wire 71, so that the amplified voltage from the voltage amplifier circuit 50 can drive the light-emitting element 60 to shine. Here, the electrical conduction wire 71 can be mounted on the inner surface of the helmet 10 by SMD technology, so as to avoid the wire from being pulled and also the danger caused therefrom.

In the aforesaid, the present invention utilizes the solar photovoltaic panel 20 to absorb the solar energy and transform thereof into the electricity, which is then used to charge the secondary battery 40, so that as the light source is absent, the secondary battery 40 can be discharged to drive the light-emitting element 60 to shine. Therefore, even the helmet 10 is used in a dark environment, the light-emitting element 60 also can shine to provide the warning effect and secure the user's safety. Furthermore, through the voltage amplifier circuit 50, the power unit of the warning device can be configured to have a smaller voltage potential, so as to avoid the usage of multiple series-connected batteries, thereby reducing the occupied volume of the power unit and also the total weight of the helmet 10. Therefore, the user can have an easier and freer wearing experience.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A solar-charged warning device, mounted on a helmet, comprising:
a solar photovoltaic panel, mounted on the outer surface of the helmet for absorbing solar energy and transforming thereof into electricity;
a charge/discharge circuit, electrically connected to the solar photovoltaic panel;
a secondary battery, electrically connected to the charge/discharge circuit for receiving and storing the electricity produced from the solar photovoltaic panel, and powered by the charge/discharge circuit;
a voltage amplifier circuit, electrically connected to the charge/discharge circuit, for amplifying the voltage of the power from the secondary battery; and
at least one light-emitting element, mounted on the outer surface of the helmet and electrically connected to the voltage amplifier circuit via an electrical conduction wire, so as to shine as being driven by the amplified voltage from the voltage amplifier circuit.

2. The solar-charged warning device as claimed in claim 1, wherein a sensor circuit is further located between the solar photovoltaic panel and the charge/discharge circuit, and the charge/discharge circuit is feedback to the sensor circuit, wherein when there detects the electricity produced from the solar photovoltaic panel, the sensor circuit controls the charge/discharge circuit to charge the secondary battery, and when there detects no electricity produced from the solar photovoltaic panel, the sensor circuit controls the charge/discharge circuit to discharge the secondary battery.

3. The solar-charged warning device as claimed in claim 1, wherein the secondary battery is selected from a Li battery, a Ni—H battery or a storage battery.

4. The solar-charged warning device as claimed in claim 1, wherein the light-emitting element is an LED (Light Emitting Diode).

5. The solar-charged warning device as claimed in claim 1, wherein the light-emitting element is respectively mounted at the front and the rear ends of the helmet.

6. The solar-charged warning device as claimed in claim 1, wherein the solar photovoltaic panel is mounted on the outer surface of the helmet.

7. The solar-charged warning device as claimed in claim 1, wherein the helmet further includes a circuit board therein for mounting the charge/discharge circuit and the voltage amplifier circuit.

8. The solar-charged warning device as claimed in claim 7, wherein the electrical conduction wire is mounted on the inner surface of the helmet by SMD technology.

9. The solar-charged warning device as claimed in claim 1, wherein the solar photovoltaic panel is further protected by a transparent sheet.
